(19) United States
(12) Patent Application Publication
(10) Pub. No.: US 2019/0278767 A1
(43) Pub. Date: Sep. 12, 2019

(54) SMART CONTRACT UPGRADE METHOD AND SYSTEM BASED ON ALLIANCE CHAIN

(71) Applicant: ZhongAn Information Technology Service Co., Ltd., Shenzhen (CN)

(72) Inventors: Jingqi CAO, Shenzhen (CN); Zhengchao TANG, Shenzhen (CN)

(21) Appl. No.: 16/421,588

(22) Filed: May 24, 2019

Related U.S. Application Data
(63) Continuation of application No. PCT/CN2018/095811, filed on Jul. 16, 2018.

(30) Foreign Application Priority Data
Aug. 23, 2017 (CN) 201710731708.8

(51) Int. Cl. G06F 16/23

(52) U.S. Cl. CPC G06F 16/2379; G06F 16/2365

(57) ABSTRACT

Embodiments of the present disclosure disclose a smart contract upgrade method and system based on an alliance chain. The smart contract upgrade method includes: receiving an upgrade transaction submitted through an alliance chain invocation interface; performing a verification on the upgrade transaction in order to verify whether the update transaction is initiated by a creator of an original smart contract through an authorization node; and submitting the upgrade transaction to the alliance chain, when a verification result is that the upgrade transaction is initiated by the creator of the original smart contract through the authorization node, so that the alliance chain receives and executes the upgrade transaction, and writes an execution code of a new smart contract into a storage location of the corresponding original smart contract.

### CROSS-REFERENCE TO RELATED APPLICATIONS

This application is a continuation of International Application No. PCT/CN2018/095811 filed on Jul. 16, 2018, which claims priority to Chinese Patent Application No. 201710731708.8 filed on Aug. 23, 2017. Both applications are incorporated herein in their entireties by reference.

### TECHNICAL FIELD

The present disclosure relates to block chain technology, and more particularly to a smart contract upgrade method and system based on an alliance chain.

### BACKGROUND

Based on a decentralized peer-to-peer network, blockchain (block chain) combines cryptography principles with consensus mechanisms to guarantee that the data of distributed nodes is of consistency and continuity, and that the information in the block chain is of characteristics such as instant verifiability, traceability, difficulty in tampering and so on. Thus a private, efficient and secure distributed trust system is created.

Block chain is usually divided into public chain, alliance chain and private chain according to access rights. The public chain is a block chain that anyone may access and participate in consensus according to a protocol; the alliance chain is a block chain whose consensus process is controlled by pre-selected nodes; and the private chain is a block chain of which permissions are owned by one organization and are completely controlled by the organization.

Smart contract is a decentralized application framework that achieves complex functions and runs on the block chain. The smart contract is usually written in a high-level language, and is converted to a code recognizable and executable by the block chain after the smart contract is compiled by the corresponding compiler. The smart contract is deployed in the block chain and provides corresponding functions.

In existing block chain technology, the smart contract may not be modified after being deployed successfully. But in reality, there may be loopholes in the smart contract, and there is a demand to modify a portion of the smart contract within the promissory and allowable range. However, the smart contract has an characteristic that cannot be modified, which may cause serious consequences due to the loopholes in the contract and increase redundant work that a new contract has to be created due to a minor modify requirement. Thus, the upgrade of the smart contract has become a key problem that restricts the flexibility of the smart contract.

### SUMMARY

Embodiments of the present disclosure provide a smart contract upgrade method and system based on an alliance chain, which may achieve a low-cost upgrade of the smart contract on the premise of guaranteeing the compatibility.

According to a first aspect of the embodiments of the present disclosure, a smart contract upgrade method based on an alliance chain is provided, including: receiving an upgrade transaction submitted through an alliance chain invocation interface; performing a verification on the upgrade transaction in order to verify whether the update transaction is initiated by a creator of an original smart contract through an authorization node; and submitting the upgrade transaction to the alliance chain when a verification result is that the upgrade transaction is initiated by the creator of the original smart contract through the authorization node, so that the alliance chain receives and executes the upgrade transaction, and writes an execution code of a new smart contract into a storage location of the corresponding original smart contract.

In some embodiments of the present disclosure, the verification is a second verification, and the receiving an upgrade transaction submitted through an alliance chain invocation interface includes: receiving the upgrade transaction submitted through the alliance chain invocation interface, when a first verification result is that the upgrade transaction is initiated by the creator of the original smart contract, the first verification result is obtained by performing a first verification on the upgrade transaction through the alliance chain invocation interface.

In some embodiments of the present disclosure, before the receiving the upgrade transaction submitted through the alliance chain invocation interface, the smart contract upgrade method further includes: receiving the upgrade transaction on the original smart contract deployed on the alliance chain, initiated through the alliance chain invocation interface; and performing the first verification on the upgrade transaction through the alliance chain invocation interface in order to verify whether the update transaction is initiated by the creator of the original smart contract.

In some embodiments of the present disclosure, the smart contract upgrade method further includes: receiving an address of the original smart contract submitted through the alliance chain invocation interface, the performing the first verification on the upgrade transaction through the alliance chain invocation interface includes: calculating a judgement nonce value, based on an account address of the creator of the original smart contract and a current account nonce value of the creator of the original smart contract; and determining whether the upgrade transaction is initiated by the creator of the original smart contract based on the judgement nonce value.

In some embodiments of the present disclosure, the determining whether the upgrade transaction is initiated by the creator of the original smart contract based on the judgement nonce value includes: determining that the upgrade transaction is initiated by the creator of the original smart contract, if the address of the original smart contract is obtained by calculating the judgement nonce value and the account address.

In some embodiments of the present disclosure, the smart contract upgrade method further includes: determining that the upgrade transaction is not initiated by the creator of the original smart contract, if the address of the original smart contract fails to be obtained by calculating the judgement nonce value and the account address.

In some embodiments of the present disclosure, the performing a verification on the upgrade transaction includes: obtaining an address of the smart contract by calculating the account address and the judgement nonce value, and comparing the address of the smart contract with the address of the original smart contract; and determining that the upgrade transaction is initiated by the creator of the original smart contract through the authorization node, if the address of the smart contract is consistent with the address of the original smart contract.

In some embodiments of the present disclosure, the smart contract upgrade method further includes: determining that the upgrade transaction is not initiated by the creator of the original smart contract through the authorization node, if the address of the smart contract is inconsistent with the address of the original smart contract.

In some embodiments of the present disclosure, the smart contract upgrade method further includes: determining an address of the original smart contract as a parameter of the upgrade transaction and an account nonce value while the creator of the original smart contract creates the original smart contract as another parameter of the upgrade transaction, the account nonce value is obtained by calculating an account address of the creator of the original smart contract and a current account nonce value of the creator of the original smart contract.

In some embodiments of the present disclosure, the receiving an upgrade transaction submitted through an alliance chain invocation interface includes: receiving the upgrade transaction, which is packaged into a transaction of standard format and submitted through the alliance chain invocation interface.

In some embodiments of the present disclosure, the smart contract upgrade method further includes: applying a pre-compiled contract address as a recognition mark of the upgrade transaction to distinguish the upgrade transaction from other transactions received by the alliance chain.

According to a second aspect of the embodiments of the present disclosure, a smart contract upgrade system based on an alliance chain is provided, including: a receiving module, configured to receive an upgrade transaction submitted through an alliance chain invocation interface; a verifying module, configured to perform a verification on the upgrade transaction in order to verify whether the update transaction is initiated by a creator of an original smart contract through an authorization node; and a submitting module, configured to submit the upgrade transaction to the alliance chain, when a verification result is that the upgrade transaction is initiated by the creator of the original smart contract through the authorization node, so that the alliance chain receives and executes the upgrade transaction, and writes an execution code of a new smart contract into a storage location of the corresponding original smart contract.

In some embodiments of the present disclosure, the verification is a second verification, the receiving module is further configured to receives the upgrade transaction submitted through the alliance chain invocation interface when a first verification result is that the upgrade transaction is initiated by the creator of the original smart contract, the first verification result is obtained by performing a first verification on the upgrade transaction through the alliance chain invocation interface.

In some embodiments of the present disclosure, the receiving module is further configured to receive the upgrade transaction on the original smart contract deployed on the alliance chain, initiated through the alliance chain invocation interface, and the verifying module is further configured to perform the first verification on the upgrade transaction through the alliance chain invocation interface in order to verify whether the update transaction is initiated by the creator of the original smart contract.

In some embodiments of the present disclosure, the receiving module is further configured to receive an address of the original smart contract submitted through the alliance chain invocation interface; and the verifying module is further configured to calculate a judgement nonce value, based on an account address of the creator of the original smart contract and a current account nonce value of the creator of the original smart contract, and determine whether the upgrade transaction is initiated by the creator of the original smart contract based on the judgement nonce value.

In some embodiments of the present disclosure, it is determined that the upgrade transaction is initiated by the creator of the original smart contract, if the address of the original smart contract is obtained by calculating the judgement nonce value and the account address.

In some embodiments of the present disclosure, it is determined that the upgrade transaction is not initiated by the creator of the original smart contract, if the address of the original smart contract fails to be obtained by calculating the judgement nonce value and the account address.

In some embodiments of the present disclosure, the verifying module is further configured to: obtain an address of the smart contract by calculating the account address and the judgement nonce value, and compare the address of the smart contract with the address of the original smart contract; and determine that the upgrade transaction is initiated by the creator of the original smart contract through the authorization node, if the address of the smart contract is consistent with the address of the original smart contract.

In some embodiments of the present disclosure, it is determined that the upgrade transaction is not initiated by the creator of the original smart contract through the authorization node, if the address of the smart contract is inconsistent with the address of the original smart contract.

In some embodiments of the present disclosure, an address of the original smart contract is determined as a parameter of the upgrade transaction and an account nonce value while the creator of the original smart contract creates the original smart contract is determined as another parameter of the upgrade transaction, the account nonce value is obtained by calculating an account address of the creator of the original smart contract and a current account nonce value of the creator of the original smart contract.

In some embodiments of the present disclosure, the receiving module is further configured to receive the upgrade transaction, which is packaged into a transaction of standard format and submitted through the alliance chain invocation interface.

In some embodiments of the present disclosure, a pre-compiled contract address is applied as a recognition mark of the upgrade transaction to distinguish the upgrade transaction from other transactions received by the alliance chain.

According to a third aspect of the embodiments of the present disclosure, a smart contract upgrade system based on an alliance chain is provided, including: a processor; and a memory for storing instructions executable by the processor; the processor is configured to: receive an upgrade transaction submitted through an alliance chain invocation interface; perform a verification on the upgrade transaction in order to verify whether the update transaction is initiated by a creator of an original smart contract through an authorization node; and submit the upgrade transaction to the alliance chain when a verification result is that the upgrade transaction is initiated by the creator of the original smart contract through the authorization node, so that the alliance chain receives and executes the upgrade transaction, and writes an execution code of a new smart contract into a storage location of the corresponding original smart contract.

According to a fourth aspect of the embodiments of the present disclosure, a computer readable storage medium is provided, which stores computer executable instructions that, when executed by a processor, cause the processor to perform a smart contract upgrade method based on an alliance chain of the first aspect of the embodiments of the present disclosure.

According to technical solutions provided by the embodiments of the present disclosure, by receiving the upgrade transaction submitted through the alliance chain invocation interface; performing the verification on the upgrade transaction in order to verify whether the update transaction is initiated by the creator of the original smart contract through the authorization node; and submitting the upgrade transaction to the alliance chain when the verification result is that the upgrade transaction is initiated by the creator of the original smart contract through the authorization node, so that the alliance chain receives and executes the upgrade transaction, and writes the execution code of the new smart contract into the storage location of the corresponding original smart contract, a low-cost upgrade of the smart contract may be achieved on the premise of guaranteeing the compatibility.

### BRIEF DESCRIPTION OF DRAWINGS

FIG. 1 is a flowchart of a smart contract upgrade method based on an alliance chain according to an exemplary embodiment of the present disclosure;

FIG. 2 is a flowchart of a smart contract upgrade method based on an alliance chain according to another exemplary embodiment of the present disclosure;

FIG. 3 is a block diagram of a smart contract upgrade system based on an alliance chain according to an exemplary embodiment of the present disclosure; and

FIG. 4 is a block diagram of a system for a smart contract upgrade based on an alliance chain according to an exemplary embodiment of the present disclosure.

### DETAILED DESCRIPTION

A smart contract upgrade method and system based on an alliance chain are further described in more detail with reference to the accompanying drawings and the specific embodiments, but the detailed description should not be construed to limit the present disclosure.

In block chain technology, there are mainly two methods as illustrated follow to solve the upgrade problem of a smart contract.

A first method is achieved in a business logic of the smart contract. Namely, a function of a dynamic contract is called indirectly by configuring a routing contract, and when a contract upgrade is required, the dynamic contract is updated by the routing contract, thereby a function of an indirect upgrade contract is achieved. This method of the indirect upgrade contract needs to compile an extremely complex routing contract, and both the storage and execution of a contract additionally consume a lot of resources. In addition, if there is a loophole in the routing contract itself, the routing contract cannot be upgraded.

A second method is to modify an execution process and a storage logic of the smart contract. Namely, a function of upgrading the contract directly is achieved by appointing a retention method for the contract and customizing a data structure. Though this method of upgrading the contract directly without the disadvantage of consuming a lot of resources, it is required to appoint the retention method for the contract and customize the special data structure. Since appointing the retention method for the contract limits the flexibility of the smart contract and customizing the special data structure results in no longer compatible with the current running block chain, thus, the second method can only be implemented in a newly-created block chain.

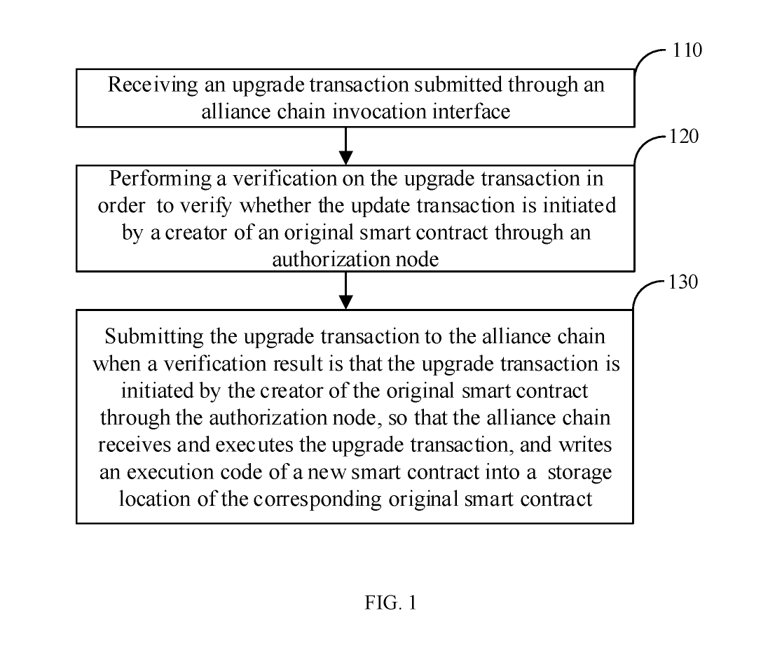

FIG. 1 is a flowchart of a smart contract upgrade method based on an alliance chain according to an exemplary embodiment of the present disclosure. As shown in FIG. 1, the smart contract upgrade method includes the following steps.

110: receiving an upgrade transaction submitted through an alliance chain invocation interface.

In some embodiments of the present disclosure, before the receiving an upgrade transaction submitted through an alliance chain invocation interface, a server receives the upgrade transaction of the original smart contract deployed on the alliance chain that is initiated through the alliance chain invocation interface; and performs a first verification on the upgrade transaction through the alliance chain invocation interface in order to verify whether the update transaction is initiated by a creator of the original smart contract.

Specifically, a server receives the upgrade transaction of the original smart contract deployed on the alliance chain initiated through the alliance chain invocation interface, and receives an address of the original smart contract submitted through the alliance chain invocation interface and an execution code of a new smart contract after the original smart contract is upgraded.

Herein, configured to upgrade the original smart contract, the upgrade transaction may be initiated by any user through any client. The address of the original smart contract may be configured to determine a storage location of the original smart contract; in addition, the address of the original smart contract may be also configured to verify an upgrade permission.

In general, there are mainly two following situations that the smart contract needs to be upgraded: a first situation is that a contract has a loophole, and a second situation is that the contract needs to be partially modified to change a contract behavior. If the smart contract needs to be significantly modified, it is usually more reasonable to create a new smart contract instead of choosing to upgrade. Thus, in the embodiments of the present disclosure, the smart contract upgrade is usually appointed within the scope of keeping the state variable of the original smart contract unchanged, allowing the appending of state variables and making addition, deletion and modification to the contract method.

Further, in order to guarantee the safety of the contract upgrade, the embodiment of the present disclosure only allows the creator of the original smart contract to initiate the contract upgrade through an authorization node. Thus, a verification of the upgrade permission may including two parts, a first part is to verify whether the update transaction is initiated by the creator of the original smart contract, which may run in the alliance chain and may also outside the alliance chain, which is not limited by the embodiments of the present disclosure; a second part is to verify whether the update transaction is initiated by the creator of the original smart contract through the authorization node.

It should be noted that the verification of the upgrade permission may only include the second part, namely, the first part may be ignored. In addition, it should be also noted that, the alliance chain invocation interface may be a part of the server, and also may be a separate client, which is not limited by the embodiments of the present disclosure.

Further, the server performs the first verification on the upgrade transaction through the alliance chain invocation interface in order to verify whether the update transaction is initiated by the creator of the original smart contract. Specifically, the server calculates a judgement nonce value based on an account address of the creator of the original smart contract and a current account nonce value of the creator of the original smart contract. If the address of the original smart contract can be obtained by calculating the judgement nonce value and the account address, it is determined that the upgrade transaction is initiated by the creator of the original smart contract. If the address of the original smart contract cannot be obtained by calculating the judgement nonce value and the account address, it is determined that the upgrade transaction is not initiated by the creator of the original smart contract.

Herein, the nonce value refers to a continuously increasing value contained in an account. The judgement nonce value, “searched” by calculating, satisfies the condition that the address of the original smart contract may be obtained by calculating the account address of the creator of the original smart contract and the judgement nonce value.

Further, when a first verification result is that the upgrade transaction is initiated by the creator of the original smart contract, the server receives the upgrade transaction submitted through the alliance chain invocation interface, wherein the first verification result is obtained by performing the first verification on the upgrade transaction through the alliance chain invocation interface by the server.

120: performing a verification on the upgrade transaction in order to verify whether the update transaction is initiated by the creator of the original smart contract through the authorization node.

In some embodiments of the present disclosure, after receiving an upgrade transaction submitted through an alliance chain invocation interface, the server performs the verification on the upgrade transaction in order to verify whether the update transaction is initiated by the creator of the original smart contract through the authorization node, herein, the verification is a second verification.

Specifically, the server calculates an address of a smart contract based on the account address and the judgement nonce value, and compares the address of the smart contract with the address of the original smart contract. And if the address of the smart contract is consistent with the address of the original smart contract, it is determined that the upgrade transaction is initiated by the creator of the original smart contract through the authorization node; if the address of the smart contract is inconsistent with the address of the original smart contract, it is determined that the upgrade transaction is not initiated by the creator of the original smart contract through the authorization node.

After the upgrade permission is verified, an execution code of a new smart contract may be written into a storage location of the corresponding original smart contract in a way that does not modify a prior data storage structure of the alliance chain and retains an original state data of the original smart contract, so a low-cost upgrade of the smart contract may be achieved on the premise of guaranteeing compatibility. In other words, the embodiment of the present disclosure does not need to modify the prior data storage structure of the alliance chain, and the original state data of the smart contract may be retained after upgrading, thus, compatibility with a current running alliance chain may be maintained.

It should be noted that the smart contract upgrade is an operation that has great influence in a block chain transaction, and usually not every node is allowed to initial the smart contract upgrade. Thus, the alliance chain usually verifies a signature of the transaction by the initiating node of the upgrade transaction. If the initiating node is an unauthorized node, subsequent executing of the transaction is refused and subsequent broadcasting the transaction to the alliance chain is cancelled. That is, in order to guarantee the safety of the contract upgrade, the embodiments of the present disclosure only allows the creator of the original smart contract to initiate the contract upgrade through the authorization node.

130: submitting the upgrade transaction to the entire alliance chain when a verification result is that the upgrade transaction is initiated by the creator of the original smart contract through the authorization node, so that the alliance chain receives and executes the upgrade transaction, and writes the execution code of the new smart contract into a storage location of the corresponding original smart contract.

In some embodiments of the present disclosure, when the verification result (namely, a second verification result) is that the upgrade transaction is initiated by the creator of the original smart contract through the authorization node, the server submits the upgrade transaction to the entire alliance chain; and after the upgrade transaction is received, the alliance chain executes the upgrade transaction and writes the execution code of the new smart contract into the storage location of the corresponding original smart contract.

Specifically, the alliance chain writes the execution code of the new smart contract into the storage location of the corresponding original smart contract when executing the upgrade transaction. Since it is usually appointed that the prior state variable of the contract keeps unchanged when the contract is upgraded, except the appending of the state variable is allowed, a prior contract state variable value is not influenced after the contract is upgraded according to a positioning rule of the smart contract for the state variable. In addition, according to a characteristics of the alliance chain of reserving history data, a modification only occurs in newly generated blocks. If it is traced back to a historical block, the result of executing a prior contract is executed, and the result is completely uninfluenced by the subsequent upgrade.

Further, after the smart contract upgrade is completed, a new call method is configured to perform a contract call, and an expected result is obtained. At the same time, an old call method no longer supported, and if forcibly performing the old call method, a correct or incorrect result is obtained according to the modification degree of the contract.

According to a technical solution provided by the embodiment of the present disclosure, by receiving the upgrade transaction submitted by the alliance chain invocation interface; performing the verification for the upgrade transaction in order to verify whether the update transaction is initiated by the creator of the original smart contract through the authorization node; and submitting the upgrade transaction to the entire alliance chain when the verification result is that the upgrade transaction is initiated by the creator of the original smart contract through the authorization node, so that the alliance chain receives and executes the upgrade transaction, and writes the execution code of the new smart contract into the storage location of the corresponding original smart contract, a low-cost upgrade of the smart contract may be achieved on the premise of guaranteeing compatibility.

In addition, the embodiment of the present disclosure does not need to configure a routing contract, which keeps the edit of the smart contract simple, thus, reducing the difficulty of editing the smart contract, and avoiding an additional calculation and a storage resource consumption due to configuring the routing contract.

In another embodiment of the present disclosure, the smart contract upgrade method further includes: receiving the address of the original smart contract submitted through the alliance chain invocation interface, wherein the performing the first verification on the upgrade transaction through the alliance chain invocation interface, includes: calculating the judgement nonce value based on the account address of the creator of the original smart contract and the current account nonce value of the creator of the original smart contract; and judging that whether the upgrade transaction is initiated by the creator of the original smart contract based on the judgement nonce value.

Specifically, the server, through the alliance chain invocation interface, calculates the judgement nonce value based on the account address of the creator of the original smart contract and the current account nonce value of the creator of the original smart contract, and determines whether the upgrade transaction is initiated by the creator of the original smart contract based on the judgement nonce value. If the address of the original smart contract can be obtained by calculating the judgement nonce value and the account address, it is determined that the upgrade transaction is initiated by the creator of the original smart contract; if the address of the original smart contract fails to be obtained by calculating the judgement nonce value and the account address, it is determined that the upgrade transaction is not initiated by the creator of the original smart contract, namely, the upgrade transaction is illegal, and “failure” is returned.

For instance, suppose a user Alice creates a contract B1 when the nonce value is 17, when using an Alice's address (Alice) and the current nonce value (17), and by a specific operation such as a “+” operation, Alice+17=B1 may be obtained. When an upgrade transaction of the contract is submitted, parameters including the address of a initiator (A) and the nonce value (N), A+N=X may be obtained by the “+” operation; if X=B1, it indicates that the initiator of the upgrade transaction is the creator of the contract, and if X≠B1, it indicates that the initiator of the upgrade transaction is not the creator of the contract.

It should be noted that the specific operation is not limited to the “+” operation described above, such as, a “−” operation, a “x” operation or the like, and the embodiments of the present disclosure sets no limitation to the specific operation.

In another embodiment of the present disclosure, the performing the second verification on the upgrade transaction, includes: obtaining the address of the smart contract by calculating the account address and the judgement nonce value, and comparing the address of the smart contract with the address of the original smart contract are; and if the address of the smart contract is consistent with the address of the original smart contract, it is determined that the upgrade transaction is initiated by the creator of the original smart contract through the authorization node.

Specially, the server (namely, an alliance chain node) calculates the address of the smart contract based on the account address and the judgement nonce value, and compares the address of the smart contract with the address of the original smart contract, and if the address of the smart contract is consistent with the address of the original smart contract, it is judged that the upgrade transaction is initiated by the creator of the original smart contract through the authorization node; if the address of the smart contract is inconsistent with the address of the original smart contract, it is judged that the upgrade transaction is not initiated by the creator of the original smart contract through the authorization node, namely, the upgrade transaction is illegal, and “failure” is returned.

It should be noted that, it is determined whether the signature is owned by the authorization node by signature information carried in the upgrade transaction, and so as to judge whether the upgrade transaction is initiated by the creator of the original smart contract through the authorization node.

In another embodiment of the present disclosure, the address of the original smart contract and an account nonce value while the creator of the original smart contract creates the original smart contract are regard as parameters of the upgrade transaction, wherein the account nonce value is calculated according to the account address and the current account nonce value.

Specially, a cyclic decrement calculation is usually performed with the account address of the creator of the original smart contract and the current account nonce value of the creator of the original smart contract, and the account nonce value while the creator of the original smart contract creates the original smart contract may be obtained.

Further, when verifying the upgrade permission subsequently, the address of the smart contract may be obtained by calculating the account nonce value while the creator of the original smart contract creates the original smart contract and the account address of the creator of the original smart contract, and be compared with the address of the original smart contract in order to verify whether the current upgrade transaction is initiated by the creator of the original smart contract through the authorization node.

In another embodiment of the present disclosure, the receiving the upgrade transaction submitted through an alliance chain invocation interface, includes: receiving the upgrade transaction, which is packaged into a transaction of standard format and submitted by the alliance chain invocation interface.

Specially, the upgrade transaction is usually packaged into a transaction of standard format according to an existing standard transaction format to guarantee compatibility, avoiding sacrificing the flexibility of the smart contract due to customizing the special retention method. Herein, an upgrade transaction of standard format usually includes a pre-compiled contract address configured as a recognition mark of the upgrade transaction, the address of the original smart contract and the account nonce value while the creator of the original smart contract creates the original smart contract.

In another embodiment of the present disclosure, the pre-compiled contract address is applied as the recognition mark of the upgrade transaction to distinguish the upgrade transaction from other transactions received by the alliance chain.

Specially, in order to distinguish the upgrade transaction from other transactions received by the alliance chain, the pre-compiled contract address is adopted as the recognition mark of the upgrade transaction. Herein, the pre-compiled contract address may be a set of addresses or a number of reserved addresses for achieving a special function in the alliance chain. The pre-compiled contract address is used to recognize the upgrade transaction based on a prior general transaction format, avoiding sacrificing the flexibility of the smart contract due to customizing the special retention method.

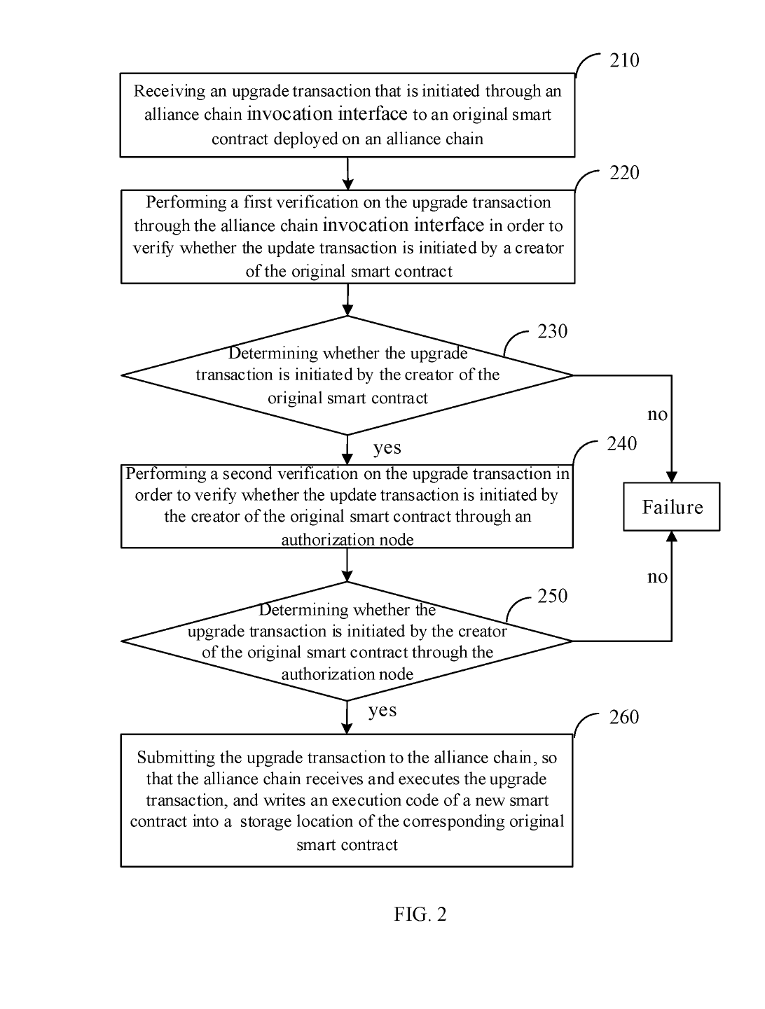

FIG. 2 is a flowchart of a smart contract upgrade method based on an alliance chain according to another exemplary embodiment of the present disclosure. As shown in FIG. 2, the smart contract upgrade method includes:

210: receiving an upgrade transaction that is initiated through an alliance chain invocation interface on an original smart contract deployed on the alliance chain.

220: performing a first verification on the upgrade transaction through the alliance chain invocation interface in order to verify whether the update transaction is initiated by a creator of the original smart contract.

230: determining whether the upgrade transaction is initiated by the creator of the original smart contract. If the upgrade transaction is initiated by the creator of the original smart contract, then 240 is executed, otherwise “failure” is returned.

240: performing a second verification on the upgrade transaction in order to verify whether the update transaction is initiated by the creator of the original smart contract through an authorization node.

250: determining whether the upgrade transaction is initiated by the creator of the original smart contract through the authorization node. If the upgrade transaction is initiated by the creator of the original smart contract through the authorization node, then 260 is executed, otherwise “failure” is returned.

260: submitting the upgrade transaction to the entire alliance chain, so that the alliance chain receives and executes the upgrade transaction, and writes an execution code of a new smart contract into a storage location of the corresponding original smart contract.

According to a technical solution provided by the embodiment of the present disclosure, by performing twice verifications to the upgrade transaction, a low-cost upgrade of a smart contract may be achieved on the premise of guaranteeing compatibility.

In addition, the embodiment of the present disclosure does not need to configure a routing contract, which keeps the edit of the smart contract simple, thus, reducing the difficulty of editing the smart contract, and avoiding an additional calculation and a storage resource consumption due to configuring the routing contract. Further, the embodiment of the present disclosure does not need to modify a prior data storage structure of the alliance chain, and an original state data of the smart contract may be retained after upgrading. Thus, compatibility with a prior running alliance chain may be maintained.

All the above alternative technical solutions may form the alternative embodiments of the present disclosure with any combination, and it will not be repeated here.

The following is an apparatus embodiment of the present disclosure, which may be configured to execute a method embodiment of the present disclosure. For details not disclosed in the apparatus embodiment of the present disclosure, please refer to the method embodiment of the present disclosure.

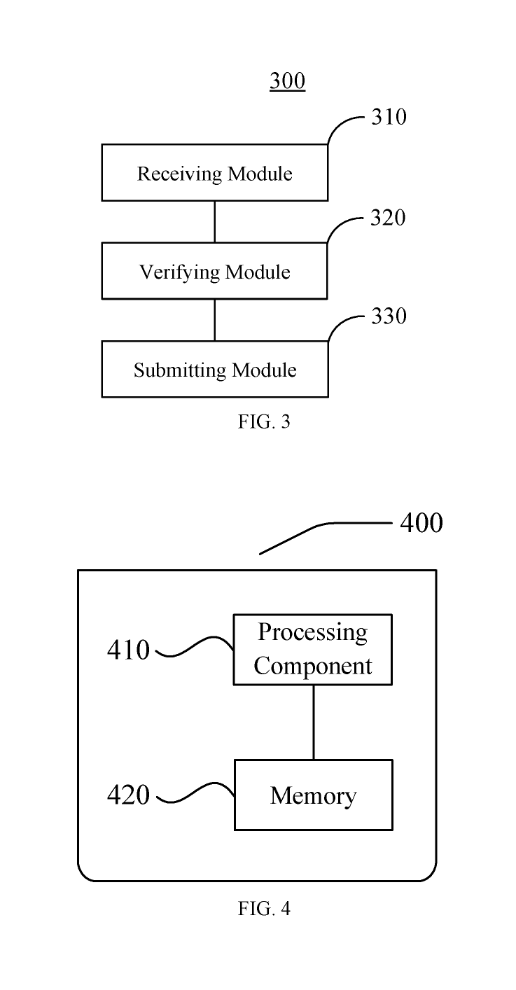

FIG. 3 is a block diagram of a smart contract upgrade system based on an alliance chain according to an exemplary embodiment of the present disclosure. As shown in FIG. 3, the smart contract upgrade system 300 includes a receiving module 310, a verifying module 320 and a submitting module 330.

The receiving module 310, configured to receive an upgrade transaction submitted through an alliance chain invocation interface.

The verifying module 320, configured to perform a second verification on the upgrade transaction in order to verify whether the update transaction is initiated by a creator of an original smart contract through an authorization node.

The submitting module 330, configured to submit the upgrade transaction to the alliance chain, when a second verification result is that the upgrade transaction is initiated by the creator of the original smart contract through the authorization node, so that the alliance chain receives and executes the upgrade transaction, and writes an execution code of a new smart contract into a storage location of the corresponding original smart contract.

According to a technical solution provided by the embodiment of the present disclosure, by receiving the upgrade transaction submitted through the alliance chain invocation interface; performing the second verification for the upgrade transaction in order to verify whether the update transaction is initiated by the creator of the original smart contract through the authorization node; and submitting the upgrade transaction to the entire alliance chain, when the second verification result is that the upgrade transaction is initiated by the creator of the original smart contract through the authorization node, so that the alliance chain receives and executes the upgrade transaction, and writes the execution code of the new smart contract into the storage location of the corresponding original smart contract, a low-cost upgrade of a smart contract may be achieved on the premise of guaranteeing compatibility.

In another embodiment of the present disclosure, the verification is the second verification, and the receiving module 310 in FIG. 3 receives the upgrade transaction submitted through the alliance chain invocation interface, when a first verification result is that the upgrade transaction is initiated by the creator of the original smart contract, wherein the first verification result is obtained by performing the first verification on the upgrade transaction through the alliance chain invocation interface.

In another embodiment of the present disclosure, the receiving module 310 in FIG. 3 receives the upgrade transaction that is initiated through the alliance chain invocation interface to the original smart contract deployed on the alliance chain, and the verifying module 320 performs the first verification on the upgrade transaction through the alliance chain invocation interface in order to verify whether the update transaction is initiated by the creator of the original smart contract.

In another embodiment of the present disclosure, the receiving module 310 in FIG. 3 receives an address of the original smart contract submitted through the alliance chain invocation interface, and the verifying module 320 calculates a judgement nonce value based on an account address of the creator of the original smart contract and a current account nonce value of the creator of the original smart contract, and determines whether the upgrade transaction is initiated by the creator of the original smart contract based on the judgement nonce value.

In another embodiment of the present disclosure, it is determined that the upgrade transaction is initiated by the creator of the original smart contract if the address of the original smart contract is obtained by calculating the judgement nonce value and the account address.

In another embodiment of the present disclosure, it is determined that the upgrade transaction is not initiated by the creator of the original smart contract if the address of the original smart contract fails to be obtained by calculating the judgement nonce value and the account address.

In another embodiment of the present disclosure, the verifying module 320 in FIG. 3 calculates an address of a smart contract based on the account address and the judgement nonce value, and compares the address of the smart contract with the address of the original smart contract, and it is determined that the upgrade transaction is initiated by the creator of the original smart contract through the authorization node if the address of the smart contract is consistent with the address of the original smart contract.

In another embodiment of the present disclosure, it is determined that the upgrade transaction is not initiated by the creator of the original smart contract through the authorization node if the address of the smart contract is inconsistent with the address of the original smart contract.

In another embodiment of the present disclosure, the address of the original smart contract and an account nonce value while the creator of the original smart contract creates the original smart contract are regard as parameters of the upgrade transaction, wherein the account nonce value is obtained by calculating the account address and the current account nonce value.

In another embodiment of the present disclosure, the receiving module 310 in FIG. 3 receives the upgrade transaction that is packaged into a transaction of standard format and submitted by the alliance chain invocation interface.

In another embodiment of the present disclosure, a pre-compiled contract address is configured as a recognition mark of the upgrade transaction to distinguish the upgrade transaction from other transactions received by the alliance chain.

The specifically implementation processes of the functions and effects of each module in the above apparatus can be referred to the implementation processes of the corresponding steps in the above methods, and it will not be redundantly described herein.

FIG. 4 is a block diagram of a system 400 for a smart contract upgrade based on an alliance chain according to an exemplary embodiment of the present disclosure.

Referring to FIG. 4, the system 400 includes a processing component 410 that further includes one or more processors, and memory resources represented by a memory 420 for storing instructions executable by the processing component 410, such as an application program. The application program stored in the memory 420 may include one or more modules each corresponding to a set of instructions. In addition, the processing component 410 is configured to execute the instructions to perform the above smart contract upgrade method based on the alliance chain.

The system 400 may also include a power supply module configured to execute power management of the system 400, and a wired or wireless network interface configured to connect the system 400 to the network, and an input/output (I/O) interface. The system 400 may operate an operating system stored in the memory 420, such as Windows Server™, Mac OS X™, Unix™, Linux™, FreeBSD™ or the like.

A non-temporary computer readable storage medium, when instructions in the storage medium are executed by the above system 400, enables the above system 400 to perform the smart contract upgrade method based on an alliance chain, including: receiving an upgrade transaction submitted by an alliance chain invocation interface; performing the verification on the upgrade transaction in order to verify whether the update transaction is initiated by a creator of an original smart contract through an authorization node; and submitting the upgrade transaction to the alliance chain when a verification result is that the upgrade transaction is initiated by the creator of the original smart contract through the authorization node, so that the alliance chain receives and executes the upgrade transaction, and writes an execution code of a new smart contract into a corresponding storage location of the original smart contract.

It should be realized for those of ordinary skill in the art that, units and algorithm steps of each example described in the embodiment disclosed herein may be achieved by electronic hardware, or a combination of computer software and electronic hardware. Whether these functions are executed in hardware or software depends on specific applications and design constraint conditions of technical solutions. Persons skilled in the art may achieve the described functions by using different methods for each specific application, but such achievement should not be considered to be beyond the scope of the present disclosure.

It should be understood clearly for those of ordinary skill in the art that, for the convenience and brevity of the description, the specific working process of the system, the apparatus and the unit described above may refer to the corresponding process in the embodiments of the foregoing method, and will not be described redundantly herein.

In the several embodiments provided by the present disclosure, it should be understood that, the disclosed systems, devices and methods may be implemented in other manners. For example, the apparatus embodiments described above are merely illustrative. For example, the division of the units is only a logical function division, and there may be other division manners in actual implementations. For example, multiple units or components may be combined or may be integrated into another system, or some features may be ignored or not executed. In addition, the mutual coupling or direct coupling or communication connection shown or discussed may be accomplished through indirect coupling or communication connection between some interfaces, devices or units, and may be electrical, mechanical or in other forms.

Units described as a separate component may or may not be physically separated. Components displayed as units may or may not be physical units, that is, may be located in one place, or may be distributed to a plurality of network units. Some or all of the units therein may be selected according to actual needs to achieve the purpose of the solution of the embodiment.

In addition, various functional units in various embodiments of the present disclosure may be integrated in one processing unit, or each unit may exist physically separately, or two or more units may be integrated in one unit.

The functions may be also stored in a computer readable storage medium if implemented in the form of software functional units and sold or used as a standalone product. Based on such understanding, the technical solution of the present disclosure or the part that contributes to the prior art, or a part of the technical solution, may be embodied in the form of a software product. The computer software product is stored in one storage medium, including several instructions configured to instruct a computer device (which may be a personal computer, a server, or a network device and so on) to execute all or a part of steps of the methods described in the embodiments of the present disclosure. The foregoing storage medium includes various mediums that may store a program check code, such as, a U disk, a mobile hard disk, a read-only memory (Read-Only Memory, ROM), a random access memory (Random Access Memory, RAM), a magnetic disk, an optical disk, or the like.

In addition, it should be also noted that the combination of various technical features in the present disclosure is not limited to the combinations described in the claims of the present disclosure or the combinations described in the specific embodiments, and all technical features described in the present disclosure may be freely combined or integrated unless there is a contradiction between them.

It should be noted that the foregoing descriptions are merely specific embodiments of the present disclosure, and it is obvious that the present disclosure is not limited to the foregoing embodiments, and there are many similar variations with it. Variations or alternatives that can be easily thought of by any person skilled in the art within the technical scope of the present disclosure should be included within the protection scope of the present disclosure.

What is claimed is:

1. A smart contract upgrade method based on an alliance chain, comprising:
receiving an upgrade transaction submitted through an alliance chain invocation interface;
performing a verification on the upgrade transaction in order to verify whether the update transaction is initiated by a creator of an original smart contract through an authorization node; and
submitting the upgrade transaction to the alliance chain when a verification result is that the upgrade transaction is initiated by the creator of the original smart contract through the authorization node, so that the alliance chain receives and executes the upgrade transaction, and writes an execution code of a new smart contract into a storage location of the corresponding original smart contract.

2. The smart contract upgrade method according to claim 1, wherein the verification is a second verification, and the receiving an upgrade transaction submitted through an alliance chain invocation interface comprises:
receiving the upgrade transaction submitted through the alliance chain invocation interface, when a first verification result is that the upgrade transaction is initiated by the creator of the original smart contract, wherein the first verification result is obtained by performing a first verification on the upgrade transaction through the alliance chain invocation interface.

3. The smart contract upgrade method according to claim 2, wherein before the receiving the upgrade transaction submitted through the alliance chain invocation interface, the smart contract upgrade method further comprises:
receiving the upgrade transaction on the original smart contract deployed on the alliance chain, initiated through the alliance chain invocation interface; and
performing the first verification on the upgrade transaction through the alliance chain invocation interface in order to verify whether the update transaction is initiated by the creator of the original smart contract.

4. The smart contract upgrade method according to claim 3, further comprising:
receiving an address of the original smart contract submitted through the alliance chain invocation interface,
wherein the performing the first verification on the upgrade transaction through the alliance chain invocation interface comprises:
calculating a judgement nonce value, based on an account address of the creator of the original smart contract and a current account nonce value of the creator of the original smart contract; and
determining whether the upgrade transaction is initiated by the creator of the original smart contract based on the judgement nonce value.

5. The smart contract upgrade method according to claim 4, wherein the determining whether the upgrade transaction is initiated by the creator of the original smart contract based on the judgement nonce value comprises:
determining that the upgrade transaction is initiated by the creator of the original smart contract, if the address of the original smart contract is obtained by calculating the judgement nonce value and the account address.

6. The smart contract upgrade method according to claim 5, further comprising:
determining that the upgrade transaction is not initiated by the creator of the original smart contract, if the address of the original smart contract fails to be obtained by calculating the judgement nonce value and the account address.

7. The smart contract upgrade method according to claim 4, wherein the performing a verification on the upgrade transaction comprises:
obtaining an address of the smart contract by calculating the account address and the judgement nonce value, and comparing the address of the smart contract with the address of the original smart contract; and
determining that the upgrade transaction is initiated by the creator of the original smart contract through the authorization node, if the address of the smart contract is consistent with the address of the original smart contract.

8. The smart contract upgrade method according to claim 7, further comprising:
determining that the upgrade transaction is not initiated by the creator of the original smart contract through the authorization node, if the address of the smart contract is inconsistent with the address of the original smart contract.

9. The smart contract upgrade method according to claim 1, further comprising:
determining, an address of the original smart contract as a parameter of the upgrade transaction and an account nonce value while the creator of the original smart contract creates the original smart contract as another parameter of the upgrade transaction, wherein the account nonce value is obtained by calculating an account address of the creator of the original smart contract and a current account nonce value of the creator of the original smart contract.

10. The smart contract upgrade method according to claim 1, wherein the receiving an upgrade transaction submitted through an alliance chain invocation interface comprises:
receiving the upgrade transaction, which is packaged into a transaction of standard format and submitted through the alliance chain invocation interface.

11. The smart contract upgrade method according to claim 1, further comprising:
applying a pre-compiled contract address as a recognition mark of the upgrade transaction to distinguish the upgrade transaction from other transactions received by the alliance chain.

12. A smart contract upgrade system based on an alliance chain, comprising:
a processor; and
a memory for storing instructions executable by the processor;
wherein the processor is configured to:
receive an upgrade transaction submitted through an alliance chain invocation interface;
perform a verification on the upgrade transaction in order to verify whether the update transaction is initiated by a creator of an original smart contract through an authorization node; and
submit the upgrade transaction to the alliance chain, when a verification result is that the upgrade transaction is initiated by the creator of the original smart contract through the authorization node, so that the alliance chain receives and executes the upgrade transaction, and writes an execution code of a new smart contract into a storage location of the corresponding original smart contract.

13. The smart contract upgrade system according to claim 12, wherein the verification is a second verification, the processor is further configured to: receive the upgrade transaction submitted through the alliance chain invocation interface when a first verification result is that the upgrade transaction is initiated by the creator of the original smart contract, wherein the first verification result is obtained by performing a first verification on the upgrade transaction through the alliance chain invocation interface.

14. The smart contract upgrade system according to claim 13, wherein the processor is further configured to:
receive the upgrade transaction on the original smart contract deployed on the alliance chain, initiated through the alliance chain invocation interface; and
perform the first verification on the upgrade transaction through the alliance chain invocation interface in order to verify whether the update transaction is initiated by the creator of the original smart contract.

15. The smart contract upgrade system according to claim 14, wherein the processor is further configured to:
receive an address of the original smart contract submitted through the alliance chain invocation interface; and
calculate a judgement nonce value, based on an account address of the creator of the original smart contract and a current account nonce value of the creator of the original smart contract, and determine whether the upgrade transaction is initiated by the creator of the original smart contract based on the judgement nonce value.

16. The smart contract upgrade system according to claim 15, wherein the processor is further configured to:
determine that the upgrade transaction is initiated by the creator of the original smart contract, if the address of the original smart contract is obtained by calculating the judgement nonce value and the account address.

17. The smart contract upgrade system according to claim 16, wherein the processor is further configured to:
determine that the upgrade transaction is not initiated by the creator of the original smart contract, if the address of the original smart contract fails to be obtained by calculating the judgement nonce value and the account address.

18. The smart contract upgrade system according to claim 15, wherein the processor is further configured to:
obtain an address of the smart contract by calculating the account address and the judgement nonce value, and compare the address of the smart contract with the address of the original smart contract; and
determine that the upgrade transaction is initiated by the creator of the original smart contract through the authorization node, if the address of the smart contract is consistent with the address of the original smart contract.

19. The smart contract upgrade system according to claim 18, wherein the processor is further configured to:
determine that the upgrade transaction is not initiated by the creator of the original smart contract through the authorization node, if the address of the smart contract is inconsistent with the address of the original smart contract.

20. A computer readable storage medium on which a computer executable instruction is stored, when the executable instruction is executed by a processor, cause the processor to:
receive an upgrade transaction submitted through an alliance chain invocation interface;
perform a verification on the upgrade transaction in order to verify whether the update transaction is initiated by a creator of an original smart contract through an authorization node; and
submit the upgrade transaction to the alliance chain when a verification result is that the upgrade transaction is initiated by the creator of the original smart contract through the authorization node, so that the alliance chain receives and executes the upgrade transaction, and writes an execution code of a new smart contract into a storage location of the corresponding original smart contract.
